(19) United States
(12) Patent Application Publication
(10) Pub. No.: US 2023/0206657 A1
(43) Pub. Date: Jun. 29, 2023

(54) ESTIMATION APPARATUS AND ESTIMATION METHOD

(71) Applicant: Panasonic Intellectual Property Management Co., Ltd., Osaka (JP)

(72) Inventors: Chisato IMAMURA, Osaka (JP); Takayoshi KOYAMA, Osaka (JP); Wataru NAKAI, Tokyo (JP); Motoyuki OKAYAMA, Osaka (JP)

(73) Assignee: Panasonic Intellectual Property Management Co., Ltd., Osaka (JP)

(21) Appl. No.: 17/987,210

(22) Filed: Nov. 15, 2022

(30) Foreign Application Priority Data
Dec. 24, 2021 (JP) 2021-210511

(51) Int. Cl. G06V 20/59; G06V 20/58; G06V 40/16; G06V 10/776; G06V 40/20

(52) U.S. Cl. CPC G06V 20/597; G06V 20/58; G06V 40/174; G06V 10/776; G06V 40/20

(57) ABSTRACT

An estimation apparatus includes: an image information obtainer that obtains image information of a captured image of a driver; a first detector that detects face information indicating facial behavior of the driver, based on the image information; a first reliability calculator that calculates first reliability; a second detector that detects body information indicating body movement of the driver, based on the image information; a second reliability calculator that calculates second reliability; a weight setter that, when the face information and the body information are detected, sets a first weight corresponding to the face information and a second weight corresponding to the body information based on the first reliability and the second reliability; and an estimator that estimates drowsiness of the driver based on the face information weighted by the first weight and the body information weighted by the second weight.

### CROSS REFERENCE TO RELATED APPLICATION

The present application is based on and claims priority of Japanese Patent Application No. 2021-210511 filed on Dec. 24, 2021.

### FIELD

The present disclosure relates to an estimation apparatus and an estimation method.

### BACKGROUND

An estimation apparatus that estimates drowsiness of a driver of a vehicle has been known (for example, see Patent Literature (PTL) 1). The conventional estimation apparatus detects first information about facial behavior of the driver and second information about body movement of the driver, based on image information of a captured image of the driver of the vehicle. Drowsiness of the driver is estimated by weighting each of the detected first information and second information.

### CITATION LIST

### Patent Literature

PTL 1: Japanese Patent No. 6245398

### SUMMARY

However, the conventional estimation apparatus can be improved upon.

In view of this, the present disclosure provides an estimation apparatus and an estimation method that are capable of improving upon the above related art.

An estimation apparatus according to one aspect of the present disclosure is an estimation apparatus that estimates drowsiness of a driver of a vehicle. The estimation apparatus includes: an image information obtainer that obtains image information of a captured image of the driver; a first detector that detects first information indicating facial behavior of the driver, based on the image information; a first reliability calculator that calculates first reliability, the first reliability being an indicator of certainty of a detection result of the first information; a second detector that detects second information indicating body movement of the driver, based on the image information; a second reliability calculator that calculates second reliability, the second reliability being an indicator of certainty of a detection result of the second information; a weight setter that, when the first information and the second information are detected, sets a first weight corresponding to the first information and a second weight corresponding to the second information based on the first reliability and the second reliability; and an estimator that estimates drowsiness of the driver based on the first information weighted by the first weight and the second information weighted by the second weight.

Note that these general and specific aspects may be implemented by a system, a method, an integrated circuit, a computer program, or a computer-readable recording medium such as a compact disc-read only memory (CD-ROM), or by any combination of systems, methods, integrated circuits, computer programs, and recording media.

The estimation apparatus and so on according to one aspect of the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram illustrating a configuration of an estimation apparatus according to Embodiment 1.

FIG. 2 is a flowchart illustrating operation of the estimation apparatus according to Embodiment 1.

FIG. 3 is a block diagram illustrating a configuration of an estimation apparatus according to Embodiment 2.

FIG. 4 is a flowchart illustrating operation of the estimation apparatus according to Embodiment 2.

FIG. 5 is a block diagram illustrating a configuration of an estimation apparatus according to Embodiment 3.

FIG. 6 is a flowchart illustrating operation of the estimation apparatus according to Embodiment 3.

### DESCRIPTION OF EMBODIMENTS

### Underlying Knowledge Forming Basis of the Present Disclosure

The inventors have found that the estimation apparatus described in the “Background” section has the following problem.

The conventional estimation system described above has a problem that drowsiness of the driver cannot be accurately estimated because, for example, actual driving conditions of the vehicle are not taken into account when drowsiness of the driver is estimated.

In order to solve such a problem, an estimation apparatus according to one aspect of the present disclosure is an estimation apparatus that estimates drowsiness of a driver of a vehicle. The estimation apparatus includes: an image information obtainer that obtains image information of a captured image of the driver; a first detector that detects first information indicating facial behavior of the driver, based on the image information; a first reliability calculator that calculates first reliability, the first reliability being an indicator of certainty of a detection result of the first information; a second detector that detects second information indicating body movement of the driver, based on the image information; a second reliability calculator that calculates second reliability, the second reliability being an indicator of certainty of a detection result of the second information; a weight setter that, when the first information and the second information are detected, sets a first weight corresponding to the first information and a second weight corresponding to the second information based on the first reliability and the second reliability; and an estimator that estimates drowsiness of the driver based on the first information weighted by the first weight and the second information weighted by the second weight.

With this aspect, the weight setter sets the first weight corresponding to the first information and the second weight corresponding to the second information, based on the first reliability and the second reliability that are calculated by taking into account actual driving conditions of the vehicle, for example. Use of the first weight and the second weight that have been set as described above makes it possible to accurately estimate drowsiness of the driver by taking into account actual driving conditions of the vehicle, for example.

For example, the estimation apparatus may further include a vehicle information obtainer that obtains vehicle information indicating at least one of a traveling state of the vehicle or an environment in a cabin of the vehicle. The weight setter may further change the first weight and the second weight that have been set, based on the vehicle information.

With this aspect, the first weight and the second weight can be accurately set by taking into account the vehicle information.

For example, the estimation apparatus may further include an environment information obtainer that obtains environment information indicating a surrounding environment of the vehicle. The weight setter may further change the first weight and the second weight that have been set, based on the environment information.

With this aspect, taking the environment information into account makes it possible to set the first weight and the second weight accurately.

For example, the estimation apparatus may further include a vehicle information obtainer that obtains vehicle information indicating a traveling state of the vehicle. When the weight setter determines that the vehicle is stopped or traveling around a curve based on the vehicle information, the weight setter may further change the second weight that has been set.

With this aspect, the second weight can be accurately set by taking into account the vehicle information.

For example, the second information may include skeletal point information indicating a skeletal point of the driver.

With this aspect, the detection accuracy of the second information can be improved.

For example, the second detector may track, in a time direction, the skeletal point indicated by the skeletal point information.

With this aspect, the detection accuracy of the second information can be further improved.

For example, the estimator may be configured to change a processing cycle of determining drowsiness of the driver when a predetermined condition is satisfied.

With this aspect, drowsiness of the driver can be estimated more accurately.

An estimation method according to one aspect of the present disclosure is an estimation method for estimating drowsiness of a driver of a vehicle. The estimation method includes: obtaining image information of a captured image of the driver; detecting first information indicating facial behavior of the driver, based on the image information; calculating first reliability, the first reliability being an indicator of certainty of a detection result of the first information; detecting second information indicating body movement of the driver, based on the image information; calculating second reliability, the second reliability being an indicator of certainty of a detection result of the second information; setting, when the first information and the second information are detected, a first weight corresponding to the first information and a second weight corresponding to the second information based on the first reliability and the second reliability; and estimating drowsiness of the driver based on the first information weighted by the first weight and the second information weighted by the second weight.

With this aspect, the first weight is set corresponding to the first information and the second weight is set corresponding to the second information, based on the first reliability and the second reliability that have been calculated by taking into account actual driving conditions of the vehicle, for example. Use of the first weight and the second weight set as described above makes it possible to accurately estimate the drowsiness of the driver by taking into account the actual driving conditions of the vehicle, for example.

Note that these general and specific aspects may be implemented by a system, a method, an integrated circuit, a computer program, a recording medium such as a CD-ROM, or by any combination of systems, methods, integrated circuits, computer programs, or recording media.

The following specifically describes an embodiment with reference to the drawings.

Note that each of the embodiments described below shows a general or specific example. The numerical values, shapes, materials, structural elements, the arrangement and connection of the structural elements, steps, the order of the steps, and so on mentioned in the following embodiments are mere examples and not intended to limit the present disclosure. Among the structural elements in the following embodiments, structural elements not recited in any one of the independent claims representing broadest concepts are described as optional structural elements.

### Embodiment 1

### [1-1. Configuration of Estimation Apparatus]

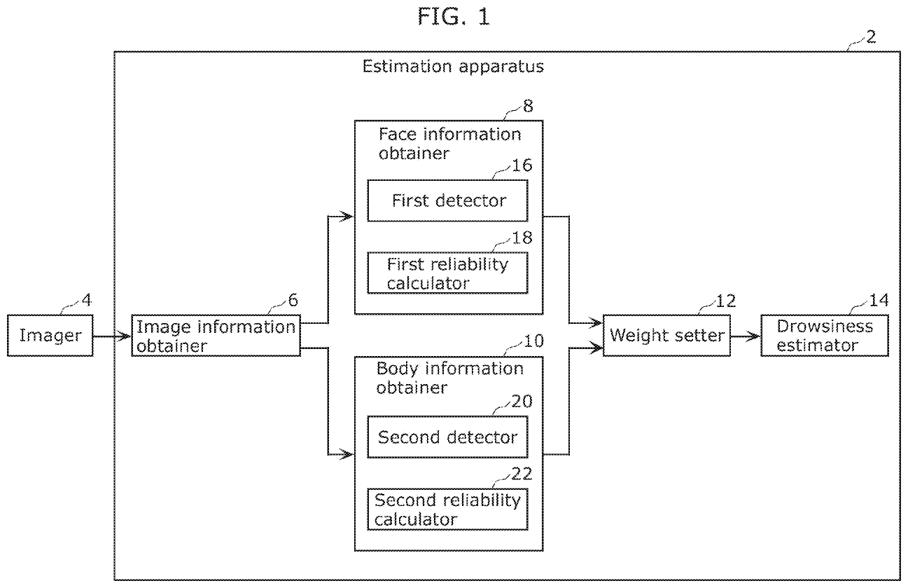

First, a configuration of estimation apparatus 2 according to Embodiment 1 will be described with reference to FIG. 1. FIG. 1 is a block diagram illustrating the configuration of estimation apparatus 2 according to Embodiment 1.

As illustrated in FIG. 1, estimation apparatus 2 according to Embodiment 1 is an apparatus for detecting drowsiness of a driver of a vehicle. The vehicle includes estimation apparatus 2 and imager 4. For example, the vehicle is a motor vehicle, such as a passenger car, a bus, or a truck. Note that the vehicle is not limited to such a motor vehicle, and may be, for example, a construction machine or an agricultural machine.

Imager 4 is a camera for capturing images of the driver sitting in the driver's seat of the vehicle, and disposed, for example, in the cabin of the vehicle. For example, a camera including a complementary metal-oxide semiconductor (CMOS) image sensor or a camera including a charge-coupled device (CCD) image sensor may be used as imager 4. Imager 4 outputs image information of the captured images of the driver to estimation apparatus 2.

Estimation apparatus 2 includes image information obtainer 6, face information obtainer 8, body information obtainer 10, weight setter 12, and drowsiness estimator 14 (an example of the estimator). Note that estimation apparatus 2 may also include the aforementioned imager 4 as a structural element.

Image information obtainer 6 obtains image information output from imager 4. Image information obtainer 6 outputs the obtained image information to each of face information obtainer 8 and body information obtainer 10.

Face information obtainer 8 is for obtaining face information (an example of first information) indicating facial behavior of the driver. For example, the facial behavior means the following movement of the driver: blinking of the eyes, wideness of opening of the eyes, the speed of opening and closing of the eyes, movement of the mouth, movement of the whole face, etc. Face information obtainer 8 includes first detector 16 and first reliability calculator 18.

First detector 16 detects face information based on the image information from image information obtainer 6. Specifically, first detector 16 analyzes images of the eyes of the driver included in the image information to detect, as face information, feature vectors that indicate facial behavior of the driver. First detector 16 outputs the detection result of the face information to weight setter 12. Note that first detector 16 may detect the face information using deep learning, for example.

First reliability calculator 18 calculates first reliability using deep learning, for example. The first reliability is an indicator of certainty of the result of the face information detected by first detector 16. The first reliability is indicated by a numerical value, for example, from 0 to 1.0. First reliability calculator 18 outputs the calculation result of the first reliability to weight setter 12.

Body information obtainer 10 is for obtaining body information (an example of second information) indicating body movement of the driver. For example, the body movement means the movement and posture of the body (head, torso, arms, etc.) of the driver. Body information obtainer 10 includes second detector 20 and second reliability calculator 22.

Second detector 20 detects body information based on image information from image information obtainer 6. Specifically, second detector 20 analyzes images of the body of the driver included in the image information to detect, as body information, feature vectors that indicate the body movement of the driver. Second detector 20 outputs the detection result of the body information to weight setter 12. Note that second detector 20 may detect the body information using deep learning, for example.

Second reliability calculator 22 calculates a second reliability using deep learning, for example. The second reliability is an indicator of certainty of the result of the body information detected by second detector 20. The second reliability is indicated by a numerical value, for example, from 0 to 1.0. Second reliability calculator 22 outputs the calculation result of the second reliability to weight setter 12.

Weight setter 12 sets, when the face information and the body information are detected, a first weight corresponding to the face information and a second weight corresponding to the body information based on the first reliability and the second reliability. Each of the first weight and the second weight is indicated by a numerical value, for example, from 0 to 1.0. Weight setter 12 outputs, to drowsiness estimator 14, the first weight and the second weight that have been set.

For example, when the first reliability is lower than the second reliability, weight setter 12 sets the first weight and the second weight to make the second weight greater than the first weight (for example, set the first weight to “0.3” and the second weight to “0.7”). For example, the cases where the first reliability is lower than the second reliability include the following cases: (a) a strong sunlight is on the face of the driver; (b) the face of the driver is darkened by a shadow; (c) the eyes of the driver are covered by, for example, sunglasses or a hand; (d) the driver squints his/her eyes due to smiling or laughing; and (e) the number of blinking is greater than or equal to a first threshold, or less than or equal to a second threshold (the first threshold>the second threshold). Note that each of the above cases can be determined based on the image information obtained by image information obtainer 6, for example. In each of the above cases, first detector 16 may not be able to accurately detect the facial behavior. Therefore, setting the second weight greater than the first weight enables drowsiness estimator 14 to accurately estimate drowsiness of the driver, as will be described later.

Note that in the present embodiment, when the first reliability is lower than the second reliability, weight setter 12 sets the first weight and the second weight to make the second weight greater than the first weight. However, instead of such a configuration, weight setter 12 may set the first weight and the second weight to make the second weight greater than the first weight when only the first reliability is lower than the threshold.

On the other hand, when the second reliability is lower than the first reliability, weight setter 12 sets the first weight and the second weight to make the first weight greater than the second weight (for example, set the first weight to “0.8” and the second weight to “0.2”). For example, the cases where the second reliability is lower than the first reliability include the following cases: (a) the driver is in a bad posture (e.g., the driver is putting his/her elbow on the door of the driver's seat or leaning on the steering wheel, etc.); (b) the driver is talking to a passenger with his/her body moving; (c) music is playing in the cabin of the vehicle and the driver is assumed to be moving the body to the rhythm; (d) the vehicle is traveling around a curve; (e) the driver is wearing thick clothes (i.e., the body information is assumed to have a large error); and (f) the driver is wearing a cast or a corset due to injury or illness. Note that each of the above cases can be determined based on the image information obtained by image information obtainer 6, for example. In each of the above cases, second detector 20 may not be able to accurately detect the body movement. Therefore, setting the first weight greater than the second weight enables drowsiness estimator 14 to accurately estimate drowsiness of the driver, as will be described later.

Note that in the present embodiment, when the second reliability is lower than the first reliability, weight setter 12 sets the first weight and the second weight to make the first weight greater than the second weight. However, instead of such a configuration, weight setter 12 may set the first weight and the second weight to make the first weight greater than the second weight when only the second reliability is lower than the threshold.

Drowsiness estimator 14 estimates drowsiness of the driver based on the face information weighted by the first weight and the body information weighted by the second weight. Specifically, drowsiness estimator 14 weights each feature of the feature vectors of the face information by the first weight, and weights each feature of the feature vectors of the body information by the second weight. In this manner, drowsiness estimator 14 estimates the drowsiness level of the driver that indicates a degree of drowsiness of the driver. The drowsiness level is indicated, for example, by a numerical value on a scale of “1” to “5”. The degree of drowsiness of the driver is higher as the numerical value of the drowsiness level increases. Specifically, the drowsiness levels are classified as follows: the drowsiness level “1” means that the driver does not appear to be sleepy at all, the drowsiness level “2” means that the driver appears to be slightly sleepy, the drowsiness level “3” means that the driver appears to be sleepy, the drowsiness level “4” means that the driver appears to be quite sleepy, and the drowsiness level “5” means that the driver appears to be very sleepy. Drowsiness estimator 14 outputs the estimated drowsiness level to an electronic control unit (ECU) in an autonomous driving system, for example.

Note that, when the drowsiness level of the driver is estimated to be, for example, “4” or higher by drowsiness estimator 14, the above-mentioned ECU causes the vehicle to fallback in order to stop the vehicle safely. The fallback means, for example, a movement of controlling the steering to bringing the vehicle to a side of a road (shoulder of a road), or controlling the engine or brakes to slow down the vehicle.

### [1-2. Operation of Estimation Apparatus]

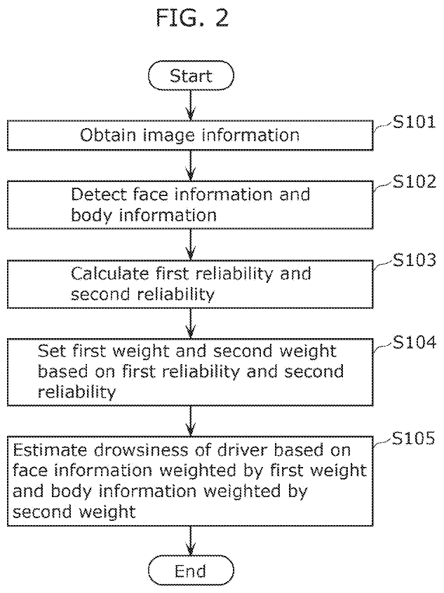

Next, operation of estimation apparatus 2 according to Embodiment 1 will be described with reference to FIG. 2. FIG. 2 is a flowchart illustrating operation of estimation apparatus 2 according to Embodiment 1.

As illustrated in FIG. 2, image information obtainer 6 obtains the image information output from imager 4 (S101), and outputs the obtained image information to each of face information obtainer 8 and body information obtainer 10.

First detector 16 of face information obtainer 8 detects face information based on image information from image information obtainer 6 (S102). First detector 16 outputs the detection result of the face information to weight setter 12.

Moreover, second detector 20 of body information obtainer 10 detects body information based on image information from image information obtainer 6 (S102). Second detector 20 outputs the detection result of the body information to weight setter 12.

First reliability calculator 18 of face information obtainer 8 calculates first reliability, which is an indicator of certainty of the result of the face information detected by first detector 16 (S103). First reliability calculator 18 outputs the calculation result of the first reliability to weight setter 12.

Moreover, second reliability calculator 22 of body information obtainer 10 calculates second reliability, which is an indicator of certainty of the result of the body information detected by second detector 20 (S103). Second reliability calculator 22 outputs the calculation result of the second reliability to weight setter 12.

Weight setter 12 sets a first weight and a second weight based on the first reliability and the second reliability (S104). Drowsiness estimator 14 estimates drowsiness of the driver based on the face information weighted by the first weight and the body information weighted by the second weight (S105).

### [1-3. Effects]

In the present embodiment, weight setter 12 sets the first weight and the second weight based on the first reliability and the second reliability that have been calculated by taking into account actual driving conditions of the vehicle, for example. Use of the first weight and the second weight that have been set as described above makes it possible to accurately estimate drowsiness of the driver by taking into account actual driving conditions of the vehicle, for example.

### Embodiment 2

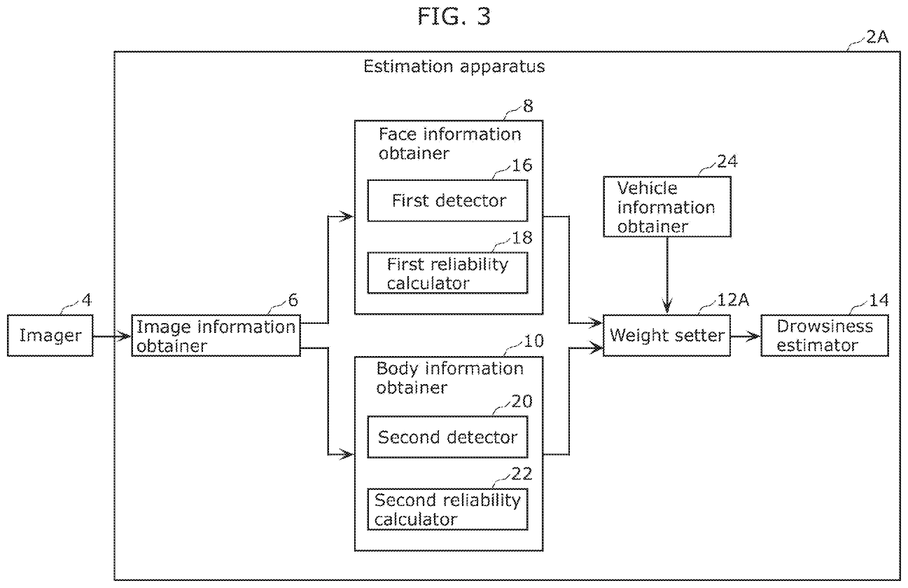

A configuration of estimation apparatus 2A according to Embodiment 2 will be described with reference to FIG. 3. FIG. 3 is a block diagram illustrating the configuration of estimation apparatus 2A according to Embodiment 2. Note that in the present embodiment, the same reference signs are assigned to the same structural elements as Embodiment 1 described above and description thereof is omitted.

As illustrated in FIG. 3, estimation apparatus 2A according to Embodiment 2 includes vehicle information obtainer 24 in addition to the structural elements in Embodiment 1 described above. Vehicle information obtainer 24 obtains vehicle information indicating the traveling state of the vehicle and the environment in the cabin of the vehicle from, for example, a controller area network (CAN) or various sensors included in the vehicle. The vehicle information indicating the traveling state of the vehicle includes, for example, (a) the traveling speed of the vehicle, (b) the type of the road on which the vehicle is traveling (general road or expressway), (c) whether the vehicle is stopped, and (d) whether the vehicle is traveling around a curve. Moreover, the vehicle information indicating the environment in the cabin of the vehicle includes, for example, (a) whether music is playing in the cabin, and (b) whether the driver is talking to a passenger in the cabin. Vehicle information obtainer 24 outputs the obtained vehicle information to weight setter 12A. Note that vehicle information obtainer 24 may obtain vehicle information indicating either one of the traveling state of the vehicle or the environment in the cabin.

Weight setter 12A changes the first weight and the second weight that have been set, based on the vehicle information indicating the traveling state of the vehicle obtained from vehicle information obtainer 24. For example, when the speed of the vehicle is relatively fast (or the vehicle is traveling on an expressway), second detector 20 may not be able to accurately detect the body movement, because shaking of the driver's body would increase due to the vibration of the vehicle. Therefore, weight setter 12A changes the first weight and the second weight to make the first weight greater than the second weight. For example, when the speed of the vehicle is relatively slow (or the vehicle is traveling on a general road), first detector 16 may not be able to accurately detect the facial behavior, because the driver would move the head to the right and left more frequently to confirm the safety of the surrounding environment of the vehicle. Therefore, weight setter 12A changes the first weight and the second weight to make the second weight greater than the first weight.

Moreover, weight setter 12A determines whether the vehicle is stopped or traveling around a curve, based on the vehicle information indicating the traveling state of the vehicle obtained from vehicle information obtainer 24. When the vehicle is stopped, the driver is highly likely to move his/her head, an arm, etc. significantly, for example, to drink something. Moreover, when the vehicle is traveling around a curve, the torso of the driver is highly likely to be inclined significantly in a right-left direction by centrifugal force. In such cases, second detector 20 may not be able to accurately detect the body movement. Therefore, when weight setter 12A determines that the vehicle is stopped or traveling around a curve, weight setter 12A changes the second weight that has been set to make the first weight greater than the second weight, for example.

Note that, when the vehicle is stopped or traveling around a curve, the result of the face information detected by first detector 16 and the result of the body information detected by second detector 20 need not be accumulated in memory, for example.

Moreover, weight setter 12A determines whether music is playing in the cabin based on the vehicle information indicating the environment in the cabin obtained from vehicle information obtainer 24. When music is playing in the cabin, the driver may move the body to the rhythm, for example, by swaying to the music. For this reason, in such cases, it is difficult to determine whether the driver is swaying to the music or the driver's body is swaying due to drowsiness. Therefore, when weight setter 12A determines that music is playing in the cabin, weight setter 12A changes the first weight and the second weight to make the first weight greater than the second weight.

Moreover, weight setter 12A determines whether the driver is talking to a passenger in the cabin based on the vehicle information indicating the environment in the cabin obtained from vehicle information obtainer 24. When the driver is talking to a passenger in the cabin, the driver's body may shake with laughter when they are having a lively conversation. For this reason, in such cases, it is difficult to determine whether the driver's body is shaking with laughter or the driver's body is swaying due to drowsiness. Therefore, when weight setter 12A determines that the driver is talking to a passenger in the cabin, weight setter 12A changes the first weight and the second weight to make the first weight greater than the second weight.

### [2-2. Operation of Estimation Apparatus]

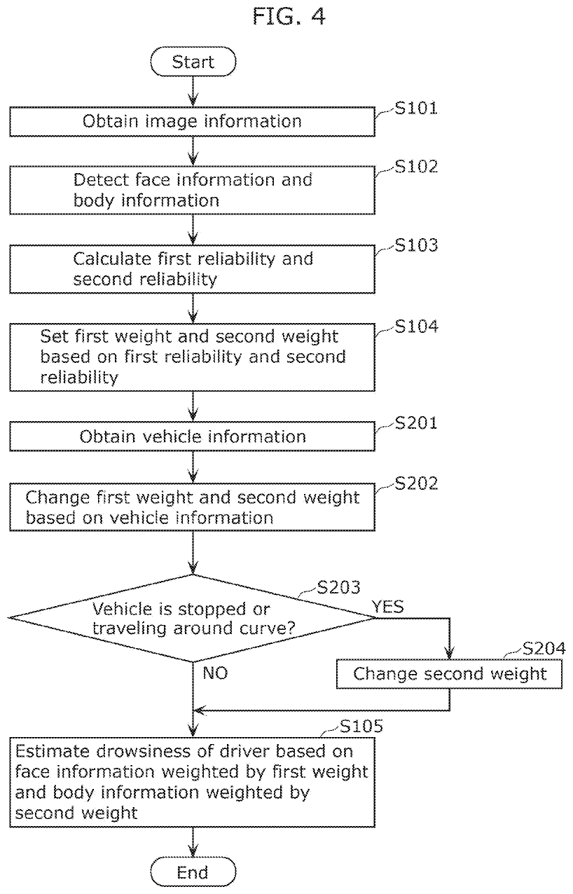

Operation of estimation apparatus 2A according to Embodiment 2 will be described with reference to FIG. 4. FIG. 4 is a flowchart illustrating the operation of estimation apparatus 2A according to Embodiment 2. Note that in the flowchart in FIG. 4, the same step number is assigned to the same processing as the processing in the flowchart in FIG. 2, and description thereof is omitted.

As illustrated in FIG. 4, steps S101 to S104 are performed first, as in Embodiment 1 described above. After step S104, vehicle information obtainer 24 obtains vehicle information (S201), for example, from the CAN included in the vehicle. Vehicle information obtainer 24 outputs the obtained vehicle information to weight setter 12A.

Weight setter 12A changes the first weight and the second weight that have been set, based on the vehicle information from vehicle information obtainer 24 (S202). Weight setter 12A outputs, to drowsiness estimator 14, the first weight and second weight that have been changed.

After that, weight setter 12A determines whether the vehicle is stopped or traveling around a curve, based on the vehicle information from vehicle information obtainer 24 (S203). When the vehicle is not stopped or not traveling around a curve (NO in S203), the process proceeds to step S105. On the other hand, when the vehicle is stopped or traveling around a curve (YES in S203), weight setter 12A changes the second weight that has been set (S204). After that, the process proceeds to step S105.

### [2-3. Effects]

In the present embodiment, the first weight and the second weight can be accurately set by taking into account the vehicle information.

### Embodiment 3

### [3-1. Configuration of Estimation Apparatus]

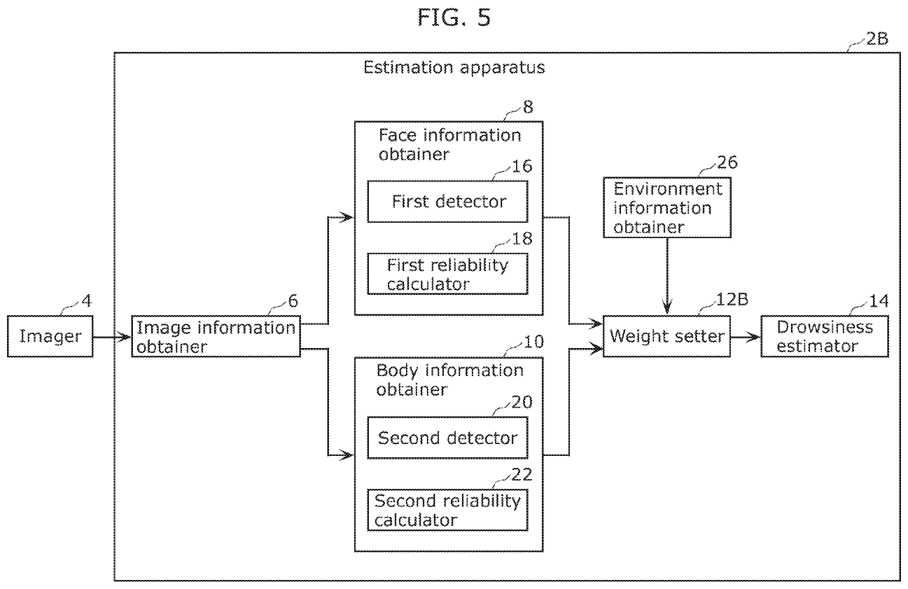

A configuration of estimation apparatus 2B according to Embodiment 3 will be described with reference to FIG. 5. FIG. 5 is a block diagram illustrating the configuration of estimation apparatus 2B according to Embodiment 3. Note that in the present embodiment, the same reference signs are assigned to the same structural elements as Embodiment 1 described above and description thereof is omitted.

As illustrated in FIG. 5, estimation apparatus 2B according to Embodiment 3 includes environment information obtainer 26 in addition to the structural elements in Embodiment 1 described above. Environment information obtainer 26 obtains environment information indicating the surrounding environment of the vehicle from, for example, the CAN and the sensors included in the vehicle. The environment information is information indicating, for example, (a) a current period of time, (b) current weather, etc. Environment information obtainer 26 outputs the obtained environment information to weight setter 12B.

Weight setter 12B changes the first weight and the second weight that have been set, based on the environment information from environment information obtainer 26. For example, when the current period of time is nighttime, first detector 16 may not be able to accurately detect the facial behavior of the driver, because the face of the driver is not illuminated by light. Therefore, weight setter 12B changes the first weight and the second weight that have been set to make the second weight greater than the first weight. For example, when the current weather is rainy, first detector 16 may not be able to accurately detect facial behavior, because the driver would move the head to the right and left more frequently to check the safety of the surrounding environment of the vehicle. Therefore, weight setter 12B changes the first weight and the second weight that have been set to make the second weight greater than the first weight.

### [3-2. Operation of Estimation Apparatus]

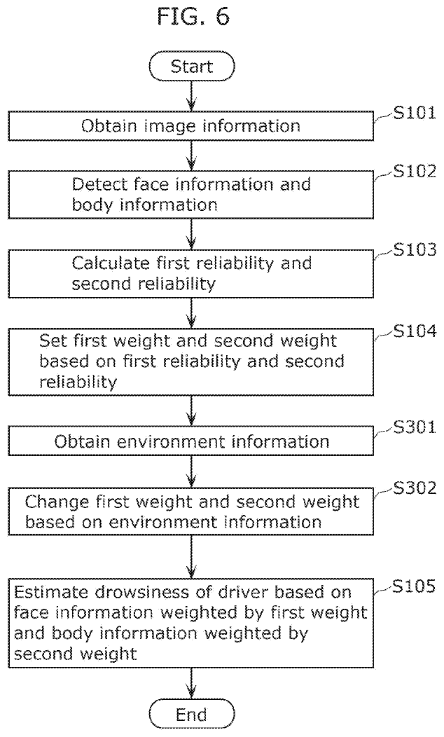

Operation of estimation apparatus 2B according to Embodiment 3 will be described with reference to FIG. 6. FIG. 6 is a flowchart illustrating operation of estimation apparatus 2B according to Embodiment 3. Note that in the flowchart in FIG. 6, the same step number is assigned to the same processing as the processing in the flowchart in FIG. 2, and description thereof is omitted.

As illustrated in FIG. 6, steps S101 to S104 are performed first, as in Embodiment 1 described above. After step S104, environment information obtainer 26 obtains environment information from, for example, the CAN and the sensors included in the vehicle (S301). Environment information obtainer 26 outputs the obtained environment information to weight setter 12B.

Weight setter 12B changes the first weight and the second weight that have been set, based on the environment information from environment information obtainer 26 (S302). Weight setter 12B outputs, to drowsiness estimator 14, the first weight and the second weight that have been changed. After that, step S105 is performed.

### [3-3. Effects]

In the present embodiment, the first weight and the second weight can be accurately set by taking into account the environment information.

### Other Variations

The estimation apparatuses according to one or more aspects have been described above based on the embodiments described above, but the present disclosure should not be limited to each of the above embodiments. Such one or more aspects may include variations achieved by making various modifications to each of the embodiments that can be conceived by those skilled in the art or forms achieved by combining structural elements in different embodiments without departing from the essence of the present disclosure.

In each of the embodiments, drowsiness estimator 14 estimates drowsiness of the driver, but this is not limiting. Drowsiness estimator 14 may estimate various kinds of conditions of the driver (e.g., in a state of microsleep, abnormal behavior, or a sudden change in physical condition, etc.)

In each of the above embodiments, second detector 20 detects body information. The body information may include skeletal point information indicating a skeletal point of the driver (e.g., a skeletal point of at least one of the following positions: the center of the head, the center of the clavicles, the right shoulder, or the left shoulder). In this case, second detector 20 may track, in a time direction, the skeletal point indicated by the skeletal point information. This allows second detector 20 to continue to perform the processing of detecting the body information even when part of the frames in the image information is missing. Alternatively, second detector 20 may improve the accuracy of classifying actions of the driver by using, for example, Graph Convolutional Networks (GCN).

Moreover, drowsiness estimator 14 may estimate drowsiness of the driver using the face information and the body information that have been detected during a predetermined processing cycle (for example, two minutes). Here, drowsiness estimator 14 may change the processing cycle of determining drowsiness of the driver when a predetermined condition is satisfied. The predetermined condition includes, for example, the following cases: (a) the driver is assumed to be eating and/or drinking while driving, (b) the face information and/or the body information is missing for greater than or equal to a predetermined period of time, and (c) the first reliability and/or the second reliability is less than or equal to the threshold. This enables more accurate estimation of drowsiness of the driver.

Moreover, in each of the above embodiments, weight setter 12 (12A, 12B) sets the first weight and the second weight based on the first reliability and the second reliability. However, for example, the first weight and the second weight may be set by multiplying the first reliability by an initial value of the first weight and multiplying the second reliability by an initial value of the second weight.

Note that in the above embodiment, each of the structural elements may include dedicated hardware, or may be achieved by executing an appropriate software program for each structural element. Each structural element may be achieved as a result of a program executor, such as a CPU or a processor, reading and executing a software program recorded on a recording medium such as a hard disk or semiconductor memory.

In addition, part or all of the functions of the estimation apparatuses according to embodiments described above may be achieved by executing a program by a processor, such as a CPU.

Part or all of the structural elements of each of the above devices may include an integrated circuit (IC) card or a single module that is detachable from each device. The IC card or the module is a computer system that includes a microprocessor, read-only memory (ROM), random-access memory (RAM), etc. The IC card or the module may include super-multifunctional large scale integration (LSI). The IC card or the module accomplishes its functions by the microprocessor operating in accordance with a computer program. The IC card or the module may have tamper resistant properties.

The present disclosure may be the method described above. Moreover, the present disclosure may be a computer program that implements these methods by a computer, or may be a digital signal that includes a computer program. Moreover, the present disclosure may be achieved by the computer program or the digital signal recorded on a non-transitory computer-readable recording medium, such as a flexible disk, a hard disk, CD-ROM, a magneto-optical (MO) disc, a digital versatile disc (DVD), DVD-ROM, DVD-RAM, a Blu-ray (registered trademark) disc (BD), and semiconductor memory. Moreover, the present disclosure may be the digital signal recorded on such recording media. In addition, the present disclosure may transmit the computer program or the digital signal via, for instance, data broadcasting or a network represented by electric telecommunication lines, wireless or wired communication lines, and the Internet. Moreover, the present disclosure may be a computer system that includes a microprocessor and memory. The memory stores the computer program mentioned above. The microprocessor may operate in accordance with the computer program. The present disclosure may also be achieved by transmitting the program or the digital signal recorded on the recording medium or by transmitting the program or the digital signal via, for example, the network, thereby enabling another independent computer system to carry out the present disclosure.

While various embodiments have been described herein above, it is to be appreciated that various changes in form and detail may be made without departing from the spirit and scope of the present disclosure as presently or hereafter claimed.

Further Information about Technical Background to this Application

The disclosure of the following patent application including specification, drawings, and claims is incorporated herein by reference in their entirety: Japanese Patent Application No. 2021-210511 filed on Dec. 24, 2021.

### INDUSTRIAL APPLICABILITY

The present disclosure is applicable to, for example, an estimation apparatus for estimating drowsiness of a driver of a vehicle.

1. An estimation apparatus that estimates drowsiness of a driver of a vehicle, the estimation apparatus comprising:
an image information obtainer that obtains image information of a captured image of the driver;
a first detector that detects first information indicating facial behavior of the driver, based on the image information;
a first reliability calculator that calculates first reliability, the first reliability being an indicator of certainty of a detection result of the first information;
a second detector that detects second information indicating body movement of the driver, based on the image information;
a second reliability calculator that calculates second reliability, the second reliability being an indicator of certainty of a detection result of the second information;
a weight setter that, when the first information and the second information are detected, sets a first weight corresponding to the first information and a second weight corresponding to the second information based on the first reliability and the second reliability; and
an estimator that estimates drowsiness of the driver based on the first information weighted by the first weight and the second information weighted by the second weight.

2. The estimation apparatus according to claim 1, further comprising:
a vehicle information obtainer that obtains vehicle information indicating at least one of a traveling state of the vehicle or an environment in a cabin of the vehicle, wherein
the weight setter further changes the first weight and the second weight that have been set, based on the vehicle information.

3. The estimation apparatus according to claim 1, further comprising:
an environment information obtainer that obtains environment information indicating a surrounding environment of the vehicle, wherein
the weight setter further changes the first weight and the second weight that have been set, based on the environment information.

4. The estimation apparatus according to claim 1, further comprising:
a vehicle information obtainer that obtains vehicle information indicating a traveling state of the vehicle, wherein
when the weight setter determines that the vehicle is stopped or traveling around a curve based on the vehicle information, the weight setter further changes the second weight that has been set.

5. The estimation apparatus according to claim 1, wherein
the second information includes skeletal point information indicating a skeletal point of the driver.

6. The estimation apparatus according to claim 5, wherein
the second detector tracks, in a time direction, the skeletal point indicated by the skeletal point information.

7. The estimation apparatus according to claim 1, wherein
the estimator is configured to change a processing cycle of determining drowsiness of the driver when a predetermined condition is satisfied.

8. An estimation method for estimating drowsiness of a driver of a vehicle, the estimation method comprising:
obtaining image information of a captured image of the driver;
detecting first information indicating facial behavior of the driver, based on the image information;
calculating first reliability, the first reliability being an indicator of certainty of a detection result of the first information;
detecting second information indicating body movement of the driver, based on the image information;
calculating second reliability, the second reliability being an indicator of certainty of a detection result of the second information;
setting, when the first information and the second information are detected, a first weight corresponding to the first information and a second weight corresponding to the second information based on the first reliability and the second reliability; and
estimating drowsiness of the driver based on the first information weighted by the first weight and the second information weighted by the second weight.
